(19) United States
(12) Patent Application Publication
(10) Pub. No.: US 2022/0287222 A1
(43) Pub. Date: Sep. 15, 2022

(54) SYSTEM AND METHOD FOR CONTROLLING THE OPERATION OF A SEED-PLANTING IMPLEMENT BASED ON FIELD CONDITIONS

(71) Applicant: CNH Industrial America LLC, New Holland, PA (US)

(72) Inventors: Chad M. Johnson, Arlington Heights, IL (US); Trevor Stanhope, Oak Lawn, IL (US); Michael Christopher Conboy, Chicago, IL (US)

(21) Appl. No.: 17/199,545

(22) Filed: Mar. 12, 2021

(51) Int. Cl. A01C 5/06; A01C 7/20; A01B 79/00; A01B 79/02; A01B 63/00

(52) U.S. Cl. CPC A01C 5/064; A01C 5/068; A01C 7/203; A01B 79/005; A01B 79/02; A01B 63/008

(57) ABSTRACT

A system for controlling an operation of a seed-planting implement includes a row unit frame and a residue removal device pivotably coupled to the row unit frame. Furthermore, the system includes a first sensor configured to capture data indicative of a position of the residue removal device relative to the row unit frame. Additionally, the system includes a computing system communicatively coupled to the first sensor, with the computing system configured to determine the position of the residue removal device relative to the row unit frame based on the data captured by the first sensor. Moreover, the computing system is configured to determine a field condition of a field across which the seed-planting implement is traveling based on the determined position of the residue removal device.

### FIELD OF THE INVENTION

The present disclosure generally relates to seed-planting implements and, more particularly, to systems and methods for controlling the operation of a seed-planting implement based on field conditions.

### BACKGROUND OF THE INVENTION

Modern farming practices strive to increase yields of agricultural fields. In this respect, seed-planting implements are towed behind a tractor or other work vehicle to disperse seed throughout a field. For example, in certain configurations, a seed-planting implement includes an opening assembly, a closing assembly, and a press wheel assembly. In this respect, as a seed-planting implement travels across a field, the opening assembly forms a furrow or trench in the soil into which seeds are deposited. Thereafter, the closing assembly closes the furrow in the soil and the press wheel assembly packs down the soil on top of the deposited seeds. Based on their functions, the performance of the opening assembly, the closing assembly, and/or the press wheel assembly may be affected by the conditions within the field across which the seed-planting implement is traveling.

Accordingly, an improved system and method for controlling the operation of a seed-planting implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for controlling an operation of a seed-planting implement. The system includes a row unit frame and a residue removal device pivotably coupled to the row unit frame. The residue removal device, in turn, includes an arm and one or more wheels supported for rotation relative to the arm, with the one or more wheels configured to remove residue from a path of the seed-planting implement. Furthermore, the system includes a first sensor configured to capture data indicative of a position of the residue removal device relative to the row unit frame. Additionally, the system includes a computing system communicatively coupled to the first sensor, with the computing system configured to determine the position of the residue removal device relative to the row unit frame based on the data captured by the first sensor. Moreover, the computing system is configured to determine a field condition of a field across which the seed-planting implement is traveling based on the determined position of the residue removal device.

In another aspect, the present subject matter is directed to a seed-planting implement. The seed-planting implement includes a tool bar and a plurality of row units supported on the tool bar. Each row unit includes a row unit frame and a residue removal device pivotably coupled to the row unit frame. The residue removal device, in turn, includes an arm and one or more wheels supported for rotation relative to the arm, with the one or more wheels configured to remove residue from a path of the row unit. Furthermore, each row unit includes a downstream tool coupled to the row unit frame, with the downstream tool configured to interact with soil at a location aft of the residue removal device relative to the direction of travel of the seed-planting implement. Additionally, the seed-planting implement includes a plurality of position sensors, with each position sensor configured to capture data indicative of a position of the residue removal device of one of the plurality of row units relative to the corresponding row unit frame. Moreover, the seed-planting implement includes a computing system communicatively coupled to the plurality of position sensors. In this respect, the computing system is configured to determine the positions of the residue removal devices of each of the plurality of row units relative to the corresponding row unit frames based on the data captured by the plurality of position sensors. In addition, the computing system is configured to determine a field condition of a field across which the seed-planting implement is being moved based on the determined positions of the residue removal devices of each of the plurality of row units. Furthermore, the computing system is configured to initiate an adjustment to an operating parameter of downstream tool of each of the plurality of row units based on the determined field condition.

In a further aspect, the present subject matter is directed to a method for controlling an operation of a seed-planting implement. The seed-planting implement, in turn, includes a row unit frame, a residue removal device pivotably coupled to the row unit frame, and a downstream tool configured to interact with soil at a location aft of the residue removal device relative to the direction of travel of the seed-planting implement. The method includes receiving, with a computing system, first sensor data indicative of a position of the residue removal device relative to the row unit frame as the seed-planting implement travels across a field. Furthermore, the method includes determining, with the computing system, the position of the residue removal device relative to the row unit frame based on the received first sensor data. Additionally, the method includes determining, with the computing system, a field condition of the field based on the determined position of the residue removal device. Moreover, the method includes initiating, with the computing system, an adjustment to an operating parameter of the downstream tool based on the determined field condition.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a seed-planting implement in accordance with aspects of the present subject matter;

FIG. 2 illustrates a side view of one embodiment of a row unit of a seed-planting implement in accordance with aspects of the present subject matter;

FIG. 3 illustrates a side view of one embodiment of a first sensor in operative association with the row unit shown in FIG. 2;

FIG. 4 illustrates a schematic view of one embodiment of a system for controlling the operation of a seed-planting implement in accordance with aspects of the present subject matter;

FIG. 5 illustrates a flow diagram providing one embodiment of example control logic for controlling the operation of a seed-planting implement in accordance with aspects of the present subject matter; and

FIG. 6 illustrates a flow diagram of one embodiment of a method for controlling the operation of a seed-planting implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the operation of a seed-planting implement. As will be described below, the seed-planting implement may include a row unit frame and a residue removal device pivotably coupled to the row unit frame. The residue removal device may, in turn, include an arm and one or more wheels supported for rotation relative to the arm, with the one or more wheels configured to remove residue from the path of the seed-planting implement. Additionally, the seed-planting implement may include one or more downstream tools configured to interact with the soil at a location(s) aft of the residue removal device. For example, such downstream tool(s) may include a gauge wheel, a closing assembly, a press wheel assembly, and/or the like.

In several embodiments, a computing system may be configured to control the operation of the downstream tool(s) based on a determined field condition(s). More specifically, as the seed-planting implement travels across a field to perform a seed-planting operation, the computing system may determine the position of the residue removal device relative to the row unit frame based on data received from a first sensor. For example, in one embodiment, the first sensor may correspond to a rotary sensor coupled between the row unit frame and the arm of the residue removal device. Furthermore, the computing system may determine one or more field conditions of the field (e.g., residue coverage, surface roughness, clod size, surface compaction, and/or the like) based on the determined position of the residue removal device. Thereafter, the computing system may initiate an adjustment to an operating parameter(s) (e.g., the force being applied to and/or the position relative to the row unit frame) of the downstream tool(s) based on the determined field condition(s).

Determining field conditions based on residue removal device position and subsequently controlling the operation of the downstream tool(s) based on such position may ensure that the desired performance of the downstream tool(s) is maintained as field conditions vary. More specifically, because the residue removal device is positioned forward of the downstream tool(s), the field condition(s) directly in front of the downstream tool(s) can be determined in real time. Thus, the disclosed systems and methods allow the operating parameter(s) of the downstream tool(s) to be adjusted as conditions within the field vary. In this respect, controlling the downstream tool(s) of the seed-planting implement based on the position of the residue removal device may improve agricultural outcomes.

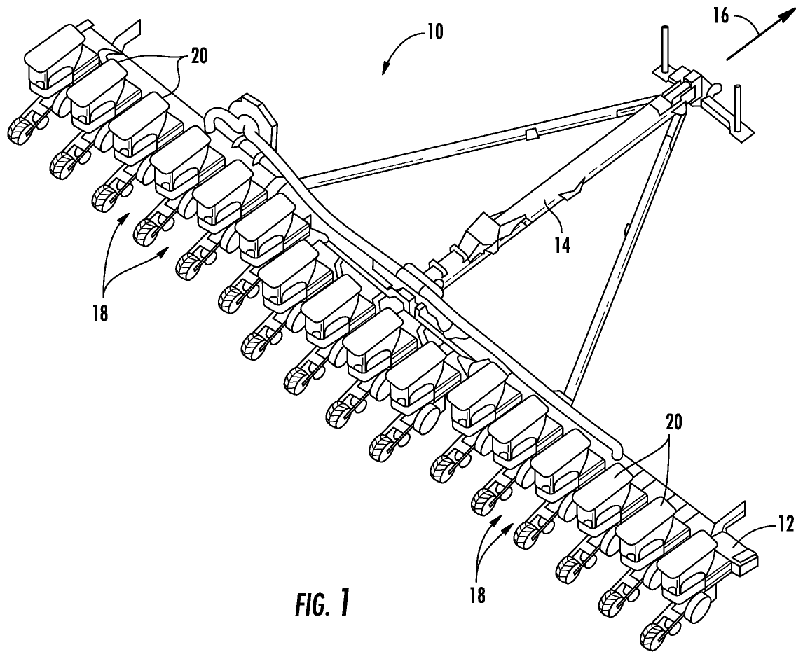

Referring now to the drawings, FIG. 1 illustrates a perspective view of one embodiment of a seed-planting implement 10 in accordance with aspects of the present subject matter. Although the seed-planting implement 10 illustrated herein corresponds to a planter, the seed-planting implement 10 may generally correspond to any suitable equipment or implement, such as seeder or another seed-dispensing implement, a side dresser or another fertilizer-dispensing implement, a strip tiller, and/or the like.

As shown in FIG. 1, the seed-planting implement 10 may include a laterally extending tool bar or frame assembly 12 connected at its middle to a forwardly extending tow bar 14 to allow the implement 10 to be towed by a work vehicle (not shown), such as an agricultural tractor, in a direction of travel (indicated by arrow 16). The tool bar 12 may generally support a plurality of seed planting units or row units 18. In general, each row unit 18 may be configured to deposit seeds at a desired depth beneath the soil surface and at a desired seed spacing as the seed-planting implement 10 is being towed by the work vehicle, thereby establishing rows of planted seeds. In some embodiments, the bulk of the seeds to be planted may be stored in one or more central hoppers (not shown) supported on the tool bar 12 and/or the tow bar 14. Thus, as seeds are planted by the row units 18, a pneumatic distribution system (not shown) may distribute seeds from the central hopper(s) to seed tanks 20 to the individual row units 18.

The seed-planting implement 10 may include any number of row units 18, such as six, eight, twelve, sixteen, twenty-four, thirty-two, or thirty-six row units. In addition, the lateral spacing between row units 18 may be selected based on the type of crop being planted. For example, the row units 18 may be spaced approximately thirty inches from one another for planting corn and approximately fifteen inches from one another for planting soybeans.

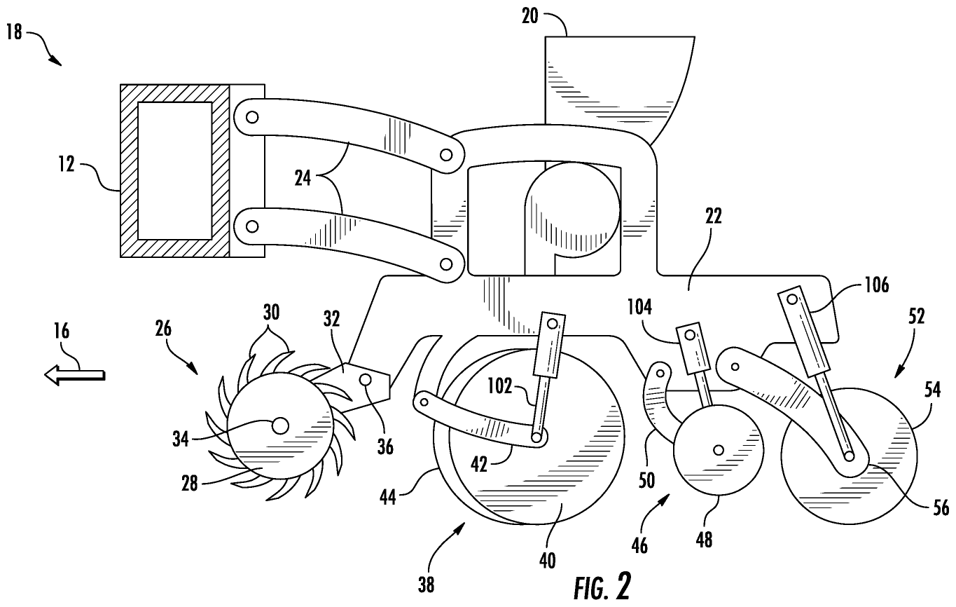

Referring now to FIG. 2, a side view of one embodiment of a row unit 18 is illustrated in accordance with aspects of the present subject matter. As shown, the row unit 18 may include a row unit frame 22 adjustably coupled to the tool bar 12 by links 24. For example, one end of each link 24 may be pivotably coupled to the row unit frame 22, while an opposed end of each link 24 may be pivotably coupled to the tool bar 12. However, in alternative embodiments, the row unit 18 may be coupled to the tool bar 12 in any other suitable manner.

As shown in FIG. 2, the row unit 18 includes a residue removal device 26 pivotably coupled to the row unit frame 22 at its forward end relative to the direction of travel 16. In general, the residue removal device 26 may be configured to break up and/or sweep away or otherwise remove residue, dirt clods, and/or the like from the path of the row unit 18. As such, in several embodiments, the residue removal device 26 may include a pair of wheels 28 (one is shown), with each wheel 28 having a plurality of tillage points or fingers 30. As such, the wheels 28 may be configured to roll relative to the soil as the seed-planting implement 10 travels across the field such that the fingers 30 break up and/or sweep away residue and dirt clods. Additionally, the residue removal device 26 may include a support arm 32 that adjustably couples the wheels 28 to the row unit frame 22. For example, one end of the support arm 32 may be pivotably coupled to the wheels 28 via an axle 34, while an opposed end of the support arm 32 may be pivotably coupled to the row unit frame 22 via a pivot joint 36. However, in alternative embodiments, the residue removal device 26 may have any other suitable configuration. For example, in one embodiment, the residue removal device 26 may include only a single wheel 28.

Additionally, the row unit 18 may include one or more downstream tools positioned aft of the residue removal device 26 relative to the direction of travel 16. As such, the downstream tool(s) may be configured to interact with soil at a location(s) aft of the residue removal device 26. In this respect, and as will be described below, the downstream tool(s) may facilitate the formation and subsequent closing of a furrow or trench within the soil into which seeds are deposited.

In several embodiments, the downstream tool(s) may include an opening assembly 38 supported on the row unit frame 22. In general, the opening assembly 38 may be configured to form the furrow or trench within the soil. More specifically, in some embodiments, the opening assembly 38 may include a gauge wheel 40 adjustably coupled to the row unit frame 22 via a support arm 42. Furthermore, the opening assembly 38 may also include one or more opener disks 44 configured to excavate a furrow or trench within the soil. Thus, as the seed-planting implement 10 travels across the field, the gauge wheel 40 may be configured to engage the top surface of the soil. In this respect, the position of the gauge wheel 40 relative to the row unit frame 22 may set the penetration of the opener disk(s) 44 (and, thus, the depth of the furrow being excavated).

Moreover, in several embodiments, the downstream tool(s) may include a closing assembly 46 supported on the row unit frame 22. In general, the closing assembly 46 may be configured to close the furrow or trench within the soil by the opening assembly 38. Specifically, in some embodiments, the closing assembly 46 may include a pair of closing disks 48 (one is shown) adjustably coupled to the row unit frame 22 via a support arm 50. In this respect, the closing disks 48 may be positioned relative to each other such that soil flows between the disks 48 as the seed-planting implement 10 travels across the field. As such, the closing disks 58 may be configured to collapse or otherwise close the furrow after seeds have been deposited therein, such as by pushing the excavated soil into the furrow. However, in alternative embodiments, the closing assembly 46 may have any other suitable configuration. For example, in one embodiment, the closing assembly 46 may have closing wheels (not shown) in lieu of the closing disks 48.

Furthermore, in several embodiments, the downstream tool(s) may include a press wheel assembly 52 supported on the row unit frame 22. Specifically, in some embodiments, the press wheel assembly 52 may include a press wheel 54 adjustably coupled to the row unit frame 22 via a support arm 56. In this respect, as the seed-planting implement 10 travels across the field, the press wheel 54 may roll over the closed furrow to firm the soil over the seed and promote favorable seed-to-soil contact. However, in alternative embodiments, the press wheel assembly 52 may have any other suitable configuration.

Additionally, in alternative embodiments, the row unit 18 may include any other suitable downstream tools in addition to or in lieu of the opening assembly 38, the closing assembly 46, and the press wheel assembly 52. Moreover, in some embodiments, the row unit 18 may include only the opening assembly 38 and the closing assembly 46.

As shown, the row unit 18 may include one or more actuators configured to adjust one or more operating parameters of the downstream tool(s). For example, the actuator(s) may be configured to adjust the position of the downstream tool(s) relative to the row unit frame 22 and/or the force being applied to the downstream tool(s). As such, the actuator(s) may correspond to any suitable type of actuator(s), such as a fluid-driven actuator(s) (e.g., a pneumatic cylinder(s)).

In the illustrated embodiment, the row unit 18 includes an opening assembly actuator 102, a closing assembly actuator 104, and a press wheel assembly actuator 106. In this respect, the opening assembly actuator 102 may be configured to adjust one or more operating parameters of the gauge wheel 40, such as the force being applied to the gauge wheel 40 and/or the position of the gauge wheel 40 relative to the row unit frame 22 (which, in turn, adjust the penetration depth of the opener disk(s) 44). Moreover, the closing assembly actuator 104 may be configured to adjust one or more operating parameters of the closing disks 48, such as the force being applied to and/or the position relative to the row unit frame 22 (which may, in turn, adjust the penetration depth) of the closing disks 48. Additionally, the press wheel assembly actuator 106 may be configured to adjust one or more operating parameters of the press wheel 54, such as the force being applied to the press wheel 54. However, in alternative embodiments, the row unit 18 may include any other suitable actuator(s) and/or the actuator(s) may be configured to adjust any other suitable operating parameters of the downstream tool(s).

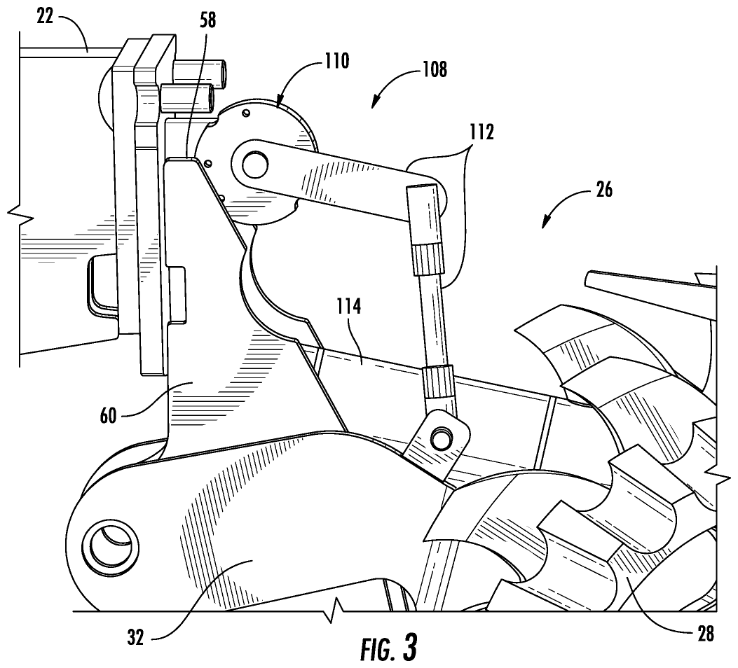

Referring now to FIG. 3, a side view of one embodiment of a first sensor 108 in operative association with the row unit 18 is illustrated in accordance with aspects of the present subject matter. In general, the first sensor 108 may be configured to capture data indicative of the position of the residue removal device 26 (and, more specifically, the wheels 28) relative to the row unit frame 22. As will be described below, the data captured by the first sensor 108 can be used to determine one or more field conditions (e.g., residue coverage, surface roughness, clod size, surface compaction, and/or the like) of the field across which the seed-planting implement 10 is traveling. Thereafter, the determined field condition(s) may be used to control the operation of the downstream tool(s) of the row unit 18.

The first sensor 108 may correspond to any suitable sensor or sensing device capable of capturing data indicative of the position of the wheels 28 of the residue removal device 26 relative to the row unit frame 22. In several embodiments, the first sensor 108 may be coupled between the row unit frame 22 and the arm 32 of the residue removal device 26. In such embodiments, the first sensor 108 may include a rotary sensor 110 (e.g., a rotary potentiometer or a magnetic rotary sensor) coupled to a bracket 58 (which is, in turn, coupled to the row unit frame 22) or the arm 32 and an associated sensor linkage 112 coupled between the rotary sensor 110 and the other of the bracket 58 or the arm 32. For instance, as shown in the illustrated embodiment, the rotary sensor 110 is coupled the bracket 58, with the sensor linkage 112 being coupled between the rotary sensor 110 and the arm 32. As such, the vertical position of the arm 32 relative to the row unit frame 22 may be detected by the rotary sensor 110 via the mechanical linkage provided by the sensor linkage 112. Thus, the position of the wheels 28 relative to the row unit frame 22 can be determined based on the data captured by the rotary sensor 110. However, in alternative embodiments, the first sensor 108 may correspond to any other suitable sensor or sensing device.

Additionally, as shown, the residue removal device 26 may include a biasing element 114 coupled between a bracket 60 (which is, in turn, coupled to the row unit frame 22) and the arm 32. In this respect, the biasing element 114 may be configured to apply a force on the arm 32. This force, in turn, may press or otherwise cause the wheels 28 of the residue removal device 26 to engage the surface of the field such that the wheels 28 roll relative to the soil and remove residue from the path of the row unit 18. In the illustrated embodiment, the biasing element 114 corresponds to a fluid-driven actuator, such as a pneumatic or hydraulic cylinder. However, in alternative embodiments, the biasing element 114 may correspond to any other suitable type of biasing element, such as such as a mechanical spring. For example, in one embodiment, the biasing element 114 may correspond to a mechanical spring and linear actuator in combination, with the linear actuator being configured to manipulate the force applied by the spring.

It should be appreciated that the configuration of the seed-planting implement 10 described above and shown in FIGS. 1-3 is provided only to place the present subject matter in an exemplary field of use. Thus, it should be appreciated that the present subject matter may be readily adaptable to any manner of seed-planting implement configuration.

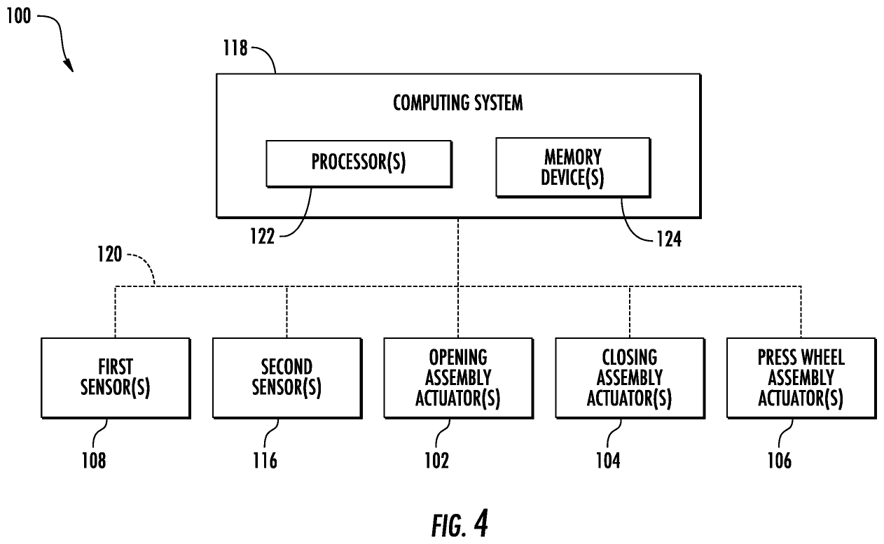

Referring now to FIG. 4, a schematic view of one embodiment of a system 100 for controlling the operation of a seed-planting implement is illustrated in accordance with aspects of the present subject matter. In general, the system 100 will be described herein with reference to the seed-planting implement 10 described above with reference to FIGS. 1-3. However, it should be appreciated by those of ordinary skill in the art that the disclosed system 100 may generally be utilized with seed-planting implements having any other suitable seed-planting implement configuration.

As shown in FIG. 4, the system 100 may include one or more second sensors 116 in operative association with the seed-planting implement 10. Each second sensor 116 may be configured to capture data indicative of the force being applied to one of the residue removal devices 26 of the seed-planting implement 10 by the corresponding biasing element 114. For example, in some embodiments, each second sensor 116 may correspond to a pressure sensor configured to data indicative of the pressure of fluid (e.g., air) being supplied to or within the corresponding biasing element 114. Thus, the force being applied to the residue removal device 26 can be determined based on the data captured by the pressure sensor. In such embodiments, the position data captured by the first sensor 108 may be used in combination with the pressure data to determine the force being applied to the residue removal device 26. In other embodiments, each second sensor 116 may correspond to a position sensor configured to capture data indicative of the compression of the biasing element 114 (e.g., the mechanical spring). However, in alternative embodiments, the second sensor 116 may correspond to any other suitable sensor or sensing device.

In accordance with aspects of the present subject matter, the system 100 may include a computing system 118 communicatively coupled to one or more components of the seed-planting implement 10 and/or the system 100 to allow the operation of such components to be electronically or automatically controlled by the computing system 118. For instance, the computing system 118 may be communicatively coupled to the first sensor(s) 108 via a communicative link 120. As such, the computing system 118 may be configured to receive data from the first sensor(s) 108 that is indicative of the position(s) of the residue removal device(s) 26 of the seed-planting implement 10 relative to the row unit frame(s) 22. Moreover, the computing system 118 may be communicatively coupled to the second sensor(s) 116 via the communicative link 120. As such, the computing system 118 may be configured to receive data from the second sensor(s) 116 that is indicative of the force(s) being applied to the residue removal device(s) 26 of the seed-planting implement 10 by the biasing element(s) 114. Furthermore, the computing system 118 may be communicatively coupled to the opening assembly actuator(s) 102, the closing assembly actuator(s) 104, and/or the press wheel assembly actuator(s) 106 of the seed-planting implement 10 via the communicative link 120. In this respect, the computing system 118 may be configured to control the operation of such actuators 102, 104, 106 in a manner that adjusts one or more operating parameters of the opening assembly(ies) 38, the closing assembly(ies) 46, and/or the press wheel assembly(ies) 52 as the seed-planting implement 10 travels across the field. Additionally, the computing system 118 may be communicatively coupled to any other suitable components of the seed-planting implement 10 and/or the system 100.

In general, the computing system 118 may comprise one or more processor-based devices, such as a given controller or computing device or any suitable combination of controllers or computing devices. Thus, in several embodiments, the computing system 118 may include one or more processor(s) 122 and associated memory device(s) 124 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 124 of the computing system 118 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 124 may generally be configured to store suitable computer-readable instructions that, when implemented by the processor(s) 122, configure the computing system 118 to perform various computer-implemented functions, such as one or more aspects of the methods and algorithms that will be described herein. In addition, the computing system 118 may also include various other suitable components, such as a communications circuit or module, one or more input/output channels, a data/control bus and/or the like.

The various functions of the computing system 118 may be performed by a single processor-based device or may be distributed across any number of processor-based devices, in which instance such devices may be considered to form part of the computing system 118. For instance, the functions of the computing system 118 may be distributed across multiple application-specific controllers or computing devices, such as an implement controller, a navigation controller, an engine controller, a transmission controller, and/or the like.

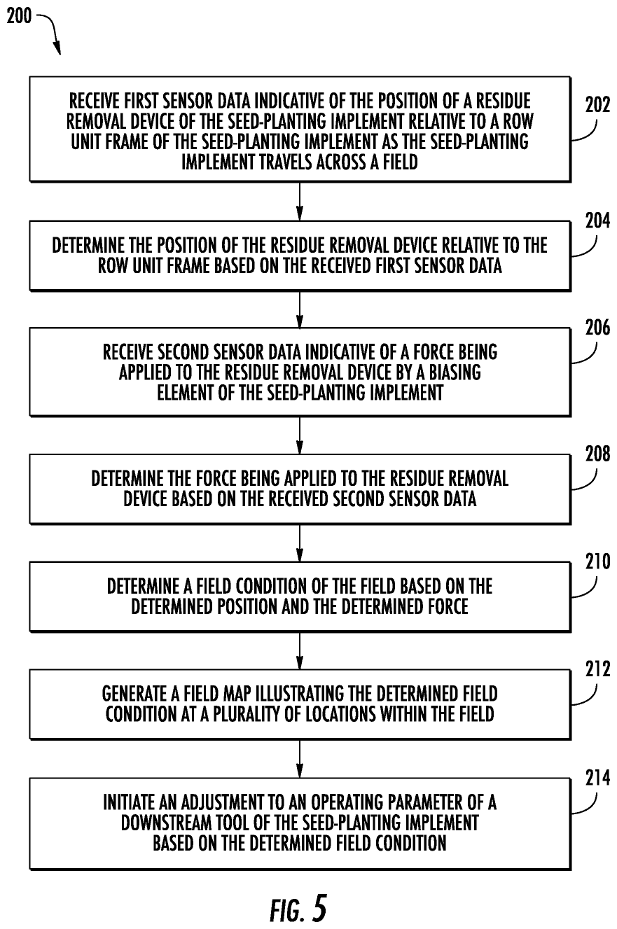

Referring now to FIG. 5, a flow diagram of one embodiment of example control logic 200 that may be executed by the computing system 118 (or any other suitable computing system) for controlling the operation of a seed-planting implement is illustrated in accordance with aspects of the present subject matter. Specifically, the control logic 200 shown in FIG. 5 is representative of steps of one embodiment of an algorithm that can be executed to control the operation of a seed-planting implement in a manner that improves the quality of seed-planting operation as field conditions vary. Thus, in several embodiments, the control logic 200 may be advantageously utilized in association with a system installed on or forming part of a seed-planting implement to allow for real-time control of the implement without requiring substantial computing resources and/or processing time. However, in other embodiments, the control logic 200 may be used in association with any other suitable system, application, and/or the like for controlling the operation of a seed-planting implement.

As shown in FIG. 5, at (202), the control logic 200 includes receiving first sensor data indicative of the position of a residue removal device of a seed-planting implement relative to the row unit frame of the seed-planting implement as the seed-planting implement travels across a field. For example, as indicated above, the computing system 118 may be communicatively coupled to the first sensor(s) 108 of the seed-planting implement 10 via the communicative link 120. In this respect, as the seed-planting implement 10 travels across the field to perform a seed-planting operation, the computing system 118 may be configured to receive data from the first sensor(s) 108 that is indicative of the position(s) of the residue removal device(s) 26 (and, more specifically, the wheels 28 of the device(s) 26) relative to the row unit frame(s) 22.

Furthermore, at (204), the control logic 200 includes determining the position of the residue removal device relative to the row unit frame based on the received first sensor data. Specifically, the computing system 118 may be configured to determine the position(s) of the residue removal device(s) 26 (and, more specifically, the wheels 28 of the device(s) 26) relative to the corresponding row unit frame 22 based on the received first sensor data (e.g., the first sensor data received at (202)). For example, the computing system 118 may include a look-up table(s), suitable mathematical formula, and/or algorithms stored within its memory device(s) 124 that correlates the received first sensor data to the position(s) of the residue removal device(s) 26.

Additionally, as shown in FIG. 5, at (206), the control logic 200 includes receiving second sensor data indicative of the force being applied to the residue removal device by a fluid-driven actuator of the seed-planting implement. For example, as indicated above, the computing system 118 may be communicatively coupled to the second sensor(s) 116 of the seed-planting implement 10 via the communicative link 120. In this respect, as the seed-planting implement 10 travels across the field to perform the seed-planting operation, the computing system 118 may be configured to receive data from the second sensor(s) 116 that is indicative of the force(s) being applied to the residue removal device(s) by the biasing element(s) 114. As mentioned above, such second sensor data may be indicative of the pressure of a fluid within and/or being supplied to the biasing element(s) 114 (e.g., when the biasing element(s) 114 correspond to a fluid-driven actuator(s)) or the compression of the biasing element(s) 114 (e.g., when the biasing element(s) 114 correspond to a mechanical spring(s)).

Moreover, at (208), the control logic 200 includes determining the force being applied to the residue removal device based on the received second sensor data. Specifically, the computing system 118 may be configured to determine the force(s) being applied to the residue removal device(s) 26 by the biasing element(s) 114 based on the received second sensor data (e.g., the second sensor data received at (206)). As mentioned above, in one embodiment, the second sensor data may correspond to the fluid pressure(s) within the biasing element(s) 114. In such an embodiment, the computing system 118 may determine the force being applied to the residue removal device(s) 26 based on the pressure(s) within/supplied to the corresponding biasing element(s) 114 and the position(s) of the residue removal device(s) 26 (e.g., the position(s) determined at (204)). In another embodiment, the second sensor data may correspond to the compression of the biasing element(s) 114. In such an embodiment, the computing system 118 may determine the force being applied to the residue removal device(s) 26 based on the compression of the biasing element(s) 114. For example, the computing system 118 may include a look-up table(s), suitable mathematical formula, and/or algorithms stored within its memory device(s) 124 that correlates the received first and/or second sensor data to the force(s) being applied to the residue removal device 26.

In addition, as shown in FIG. 5, at (210), the control logic 200 includes determining a field condition of the field based on the determined position and the determined force. More specifically, the position(s) of the residue removal device(s) 36 relative to the corresponding row unit frame 22 may be indicative of one or more field characteristics of the field across which the seed-planting implement 10 is traveling. For example, high surface roughness and/or the presence of large clods may cause the wheels 28 of the residue removal device(s) 26 to move relative to the row unit frame 22 more than low surface roughness and/or the presence of small clods. Moreover, high surface compaction may cause the wheels 28 of the residue removal device(s) 26 to be closer to the row unit frame 22 (i.e., at a higher vertical position) because it is harder from the fingers 30 of the wheels 28 to penetrate the field surface. In this respect, based on the position(s) of the residue removal device(s) 28 relative to the corresponding row unit frame 22 and the force(s) being applied to the residue removal device(s) 26, one or more field conditions of the field can be determined. As such, in several embodiments, the computing system 118 may determine the field condition(s) of the field, such as its residue coverage, surface roughness, clod size, or surface compaction, based on the determined position(s) of the residue removal device(s) 26 (e.g., the position(s) determined at (204)) and the determined force(s) being applied to the residue removal device(s) 26 (e.g., the force(s) determined at (208)). For example, the computing system 118 may include a look-up table(s), suitable mathematical formula, and/or algorithms stored within its memory device(s) 124 that correlates the determined position(s) and the determined force(s) to the field condition(s).

Furthermore, at (212), the control logic 200 includes generating a field map illustrating the determined field condition at a plurality of locations within the field. For example, in one embodiment, the computing system 118 may be configured to generate a field map illustrating the determined field condition(s) at a plurality of locations within the field.

Additionally, as shown in FIG. 5, at (214), the control logic 200 includes initiating an adjustment to an operating parameter of a downstream tool of the seed-planting implement based on the determined field condition. In several embodiments, the computing system 118 may initiate an adjustment to one or more operating parameters (e.g., the force(s) being applied to or the position(s) relative to the corresponding row unit frame 22) of one or more downstream tool(s) of the seed-planting implement 10. For example, the computing system 118 may transmit control signals to the actuator(s) associated with the downstream tool(s) via the communicative link 120. The control signals may, in turn, instruct the actuator(s) to adjust the operating parameter(s) of the corresponding the downstream tool(s).

At (214), the computing system 118 may initiate any suitable operating parameter adjustments to the downstream tool(s) of the seed-planting implement 10 based on the determined field condition(s). For example, when it is determined that high surface compaction is present within the field based at least in part on the determined position(s) of the residue removal device(s) 26, the computing system 118 may instruct the closing assembly actuator(s) 104 to increase the force being applied to the corresponding closing disks 48 of to ensure that the closing disks 48 penetrate the soil to a sufficient depth to close the furrow(s). Additionally, when it is determined that high surface roughness and/or large clods are present within the field based on the determined position(s) of the residue removal device(s) 26, the computing system 118 may instruct the opening assembly actuator(s) 102 and the closing assembly actuator(s) 104 to increase the force being applied to the gauge wheel(s) 40 and the closing disk(s) 48 to ensure that the opening and closing assemblies 38, 46 do not bounce. Moreover, in such instances, the computing system 118 may instruct the press wheel assembly actuator(s) 106 to increase the force being applied the press wheel(s) 54 to level out the soil on top of the closed furrow(s).

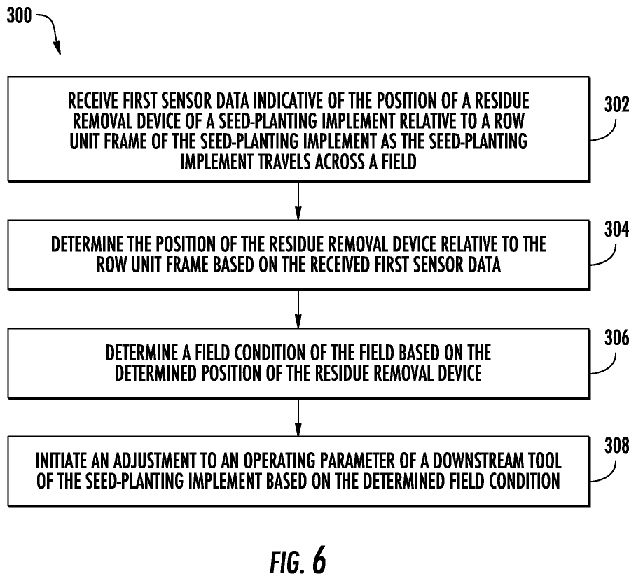

Referring now to FIG. 6, a flow diagram of one embodiment of a method 300 for controlling the operation of a seed-planting implement is illustrated in accordance with aspects of the present subject matter. In general, the method 300 will be described herein with reference to the seed-planting implement 10 and the system 100 described above with reference to FIGS. 1-4. However, it should be appreciated by those of ordinary skill in the art that the disclosed method 300 may generally be implemented with any seed-planting implement having any suitable seed-planting implement configuration and/or within any system having any suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (302), the method 300 may include receiving, with a computing system, first sensor data indicative of the position of a residue removal device of a seed-planting implement relative to a row unit frame of the seed-planting implement as the seed-planting implement travels across a field. For instance, as described above, the computing system 118 may receive data from the first sensor(s) 108 of the seed-planting implement 10 as the implement 10 travels across a field to perform a seed-planting operation. Such first sensor data may, in turn, be indicative of the position(s) of the residue removal device(s) 26 of the seed-planting implement 10 relative to the row unit frame(s) 22 of the implement 10.

Additionally, at (304), the method 300 may include determining, with the computing system, the position of the residue removal device relative to the row unit frame based on the received first sensor data. For instance, as described above, the computing system 118 may determine the position(s) of the residue removal device(s) 26 relative to the row unit frame(s) 22 based on the received first sensor data.

Moreover, as shown in FIG. 5, at (306), the method 300 may include determining, with the computing system, a field condition of the field based on the determined position of the residue removal device. For instance, as described above, the computing system 118 may determine one or more field conditions (e.g., the residue coverage, surface roughness, clod size, surface compaction, and/or the like) of the field based on the determined position(s) of the residue removal device(s) 26.

Furthermore, at (308), the method 300 may include initiating, with the computing system, an adjustment to an operating parameter of a downstream tool of the seed-planting implement based on the determined field condition. For instance, as described above, the computing system 118 may control the operation of the opening assembly actuator(s) 102, the closing assembly actuator(s) 104, and/or the press wheel assembly actuator(s) 106 of the seed-planting implement 10 in a manner that adjusts the operation of the gauge wheel(s) 40, the closing assembly assembly(ies) 46, and/or the press wheel assembly assembly(ies) 54 of the seed-planting implement 10 based on the determined field conditions.

It is to be understood that the steps of the control logic 200 and the method 300 are performed by the computing system 118 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 118 described herein, such as the control logic 200 and the method 300, is implemented in software code or instructions which are tangibly stored on a tangible computer readable medium. The computing system 118 loads the software code or instructions via a direct interface with the computer readable medium or via a wired and/or wireless network. Upon loading and executing such software code or instructions by the computing system 118, the computing system 118 may perform any of the functionality of the computing system 118 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for controlling an operation of a seed-planting implement, the system comprising:
a row unit frame;
a residue removal device pivotably coupled to the row unit frame, the residue removal device including an arm and one or more wheels supported for rotation relative to the arm, the one or more wheels configured to remove residue from a path of the seed-planting implement;
a first sensor configured to capture data indicative of a position of the residue removal device relative to the row unit frame; and
a computing system communicatively coupled to the first sensor, the computing system configured to:
determine the position of the residue removal device relative to the row unit frame based on the data captured by the first sensor; and
determine a field condition of a field across which the seed-planting implement is traveling based on the determined position of the residue removal device.

2. The system of claim 1, further comprising:
a biasing element coupled between the row unit frame and the arm, the biasing element configured to exert a force on the residue removal device;
a second sensor configured to capture data indicative of the force being exerted on the residue removal device by the biasing element,
wherein the computing system is communicatively coupled to the second sensor, the computing system further configured to:
determine the force being exerted on the residue removal device based on the data captured by the second sensor; and
determine the field condition based on both the determined force and the determined position of the residue removal device.

3. The system of claim 1, wherein the field condition comprises at least one of residue coverage, surface roughness, clod size, or surface compaction.

4. The system of claim 1, further comprising:
a downstream tool coupled to the row unit frame, the downstream tool configured to interact with soil at a location aft of the residue removal device relative to the direction of travel of the seed-planting implement,
wherein the computing system is further configured to:
initiate an adjustment to an operating parameter of the downstream tool based on the determined field condition.

5. The system of claim 4, wherein the operating parameter comprises at least one of a force being applied to or a position relative to the row unit frame of the downstream tool.

6. The system of claim 5, wherein the downstream tool comprises at least one of a gauge wheel, a closing assembly, or a press wheel of the seed-planting implement.

7. The system of claim 1, wherein the computing system is further configured to:
generate a field map illustrating the determined field condition at a plurality of locations within the field.

8. The system of claim 1, wherein the first sensor is coupled between the row unit frame and the arm of the residue removal device.

9. The system of claim 8, wherein the first sensor comprises a rotary sensing device coupled to one of the row unit frame or the arm of the residue removal device and a sensor linkage coupled between the rotary sensing device and the other of the row unit frame or the arm of the residue removal device.

10. A seed-planting implement, comprising:
a tool bar;
a plurality of row units supported on the tool bar, each row unit including:
a row unit frame;
a residue removal device pivotably coupled to the row unit frame, the residue removal device including an arm and one or more wheels supported for rotation relative to the arm, the one or more wheels configured to remove residue from a path of the row unit; and
a downstream tool coupled to the row unit frame, the downstream tool configured to interact with soil at a location aft of the residue removal device relative to the direction of travel of the seed-planting implement;
a plurality of position sensors, each position sensor configured to capture data indicative of a position of the residue removal device of one of the plurality of row units relative to the corresponding row unit frame; and
a computing system communicatively coupled to the plurality of position sensors, the computing system configured to:
determine the positions of the residue removal devices of each of the plurality of row units relative to the corresponding row unit frames based on the data captured by the plurality of position sensors;
determine a field condition of a field across which the seed-planting implement is being moved based on the determined positions of the residue removal devices of each of the plurality of row units; and
initiate an adjustment to an operating parameter of the downstream tool of each of the plurality of row units based on the determined field condition.

11. The seed-planting implement of claim 10, wherein the operating parameter comprises at least one of a force being applied to or a position relative to the row unit frame of the downstream tool of each of the plurality of row units.

12. The seed-planting implement of claim 10, wherein the downstream tool comprises a gauge wheel.

13. The seed-planting implement of claim 10, wherein the downstream tool comprises a closing assembly.

14. The seed-planting implement of claim 10, wherein the downstream tool comprises a press wheel.

15. The seed-planting implement of claim 10, wherein each position sensor comprises a rotary sensing device coupled to one of the corresponding row unit frame or the arm of the corresponding residue removal device and a sensor linkage coupled between the rotary sensing device and the other of the corresponding row unit frame or the arm of the corresponding residue removal device.

16. A method for controlling an operation of a seed-planting implement, the seed-planting implement including a row unit frame, a residue removal device pivotably coupled to the row unit frame, and a downstream tool configured to interact with soil at a location aft of the residue removal device relative to the direction of travel of the seed-planting implement, the method comprising:
receiving, with a computing system, first sensor data indicative of a position of the residue removal device relative to the row unit frame as the seed-planting implement travels across a field;
determining, with the computing system, the position of the residue removal device relative to the row unit frame based on the received first sensor data;
determining, with the computing system, a field condition of the field based on the determined position of the residue removal device; and
initiating, with the computing system, an adjustment to an operating parameter of the downstream tool based on the determined field condition.

17. The method of claim 16, wherein the seed-planting implement further includes a biasing element coupled between the row unit frame and the arm, the method further comprising:
receiving, with the computing system, second sensor data indicative of a force being applied to the residue removal device by the fluid-driven actuator;
determining, with the computing system, the force being applied to the residue removal device based on the received second sensor data; and
determining, with the computing system, the field condition based on both the determined force and the determined position of the residue removal device.

18. The method of claim 16, wherein the field condition comprises at least one residue coverage, surface roughness, or clod size.

19. The method of claim 16, wherein the operating parameter comprises at least one of a force being applied to or a position relative to the row unit frame of the downstream tool.

20. The method of claim 16, wherein the downstream tool comprises at least one of an gauge wheel, a closing assembly, or a press wheel of the seed-planting implement.
